(19) United States
(12) Patent Application Publication
(10) Pub. No.: US 2008/0192463 A1
(43) Pub. Date: Aug. 14, 2008

(54) LED ROPE LIGHT WITH A LIGHT REFRACTING LAYER ON TOP THEREOF AND AN OPAQUE LAYER AT A BOTTOM THEREOF

(75) Inventor: Ben FAN, He Shan City (CN)

Correspondence Address: PATENTTM.US, P. O. BOX 82788, PORTLAND, OR, 97282-0788, US

(73) Assignee: HE SHAN LIDE ELECTRONIC ENTERPRISE COMPANY LTD., He Shan City (CN)

(21) Appl. No.: 11/673,811

(22) Filed: Feb. 12, 2007

(51) Int. Cl. F21S 4/00

(52) U.S. Cl. 362/219

(57) ABSTRACT

A rope light with multiple light emitting diodes received therein and has a refracting layer integrally formed on top of the core to allow light from the LEDs to penetrate through the refracting layer. The refracting layer is provided with a dome having a height between 14-18 mm and a width preferably between 15-20 mm. The refracting layer has an elongated body formed with the core and the dome is directly on top of the LEDs. An opaque layer provided at the bottom and on two opposed sides of the core to prevent any light loss from the LEDs.

### BACKGROUND OF THE INVENTION

1. Field of the Invention

The present invention relates to a rope light, and more particularly to a rope light composed of multiple LEDs (light emitting diode) and having a light refracting layer on top of a body of the rope light and an opaque layer at a bottom of the rope light so as to emit bright light.

2. Description of the Prior Art

Current LED rope light is composed of multiple light emitting diodes (LED) embedded in an encapsulation to protect the LEDs from damages. The encapsulation has a circular or a rectangular cross section and when the LEDs emit light out of the encapsulation, the light away from the rope light is scattered in all directions. Therefore, the conventional rope light can not provide sufficient brightness and crystal-like illuminosity.

To overcome the shortcomings, the present invention tends to provide an improved rope light to mitigate the aforementioned problems.

### SUMMARY OF THE INVENTION

The primary objective of the present invention is to provide an improved rope light having a refracting layer on top of a core of the rope light and an opaque layer at the bottom of the core so that the light from the LEDs is able to be preserved by the opaque layer and reflected by the refracting layer to present a crystal-like illuminating effect.

In order to accomplish the objective, the rope light of the present invention includes a core having multiple longitudinal slits defined in one side of the core to intermittently receive therein light emitting diodes and joints of wires connecting two adjacent light emitting diodes and two conductive wires embedded in the core to be opposite to those of the longitudinal slits. A refracting layer is formed on top of the core and is made of a translucent material to allow light from the LEDs to be emitted out from the core. An opaque layer is provided at the bottom of the core to prevent light loss from the bottom of the core. Therefore, light from the LEDs is able to be preserved by the opaque layer and reflected by the refracting layer to present brightness.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the rope light of the present invention;

FIG. 2 is a partially cross-sectioned perspective view of the rope light in FIG. 1; and

FIG. 3 is a cross sectional view taken from line 3-3 in FIG. 3.

### DETAILED DESCRIPTION OF THE PREFERRED EMBODIMENT

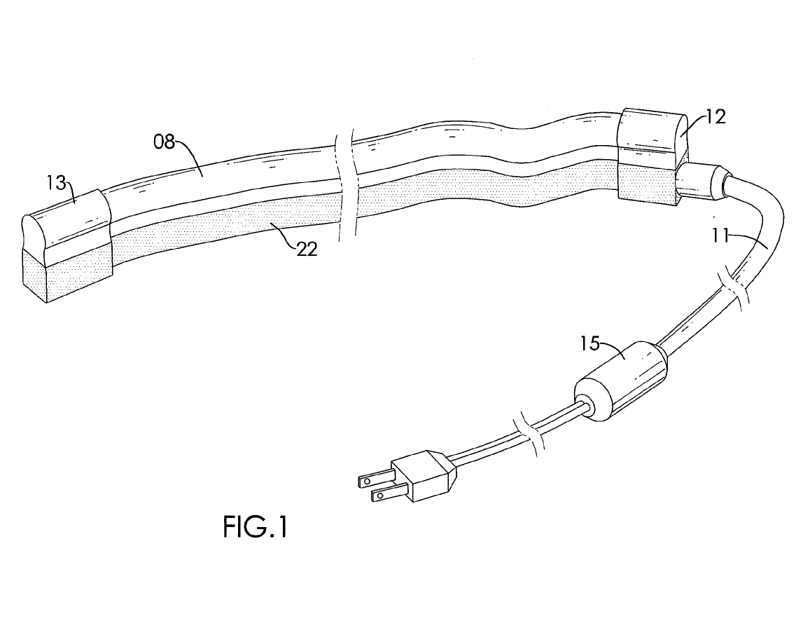

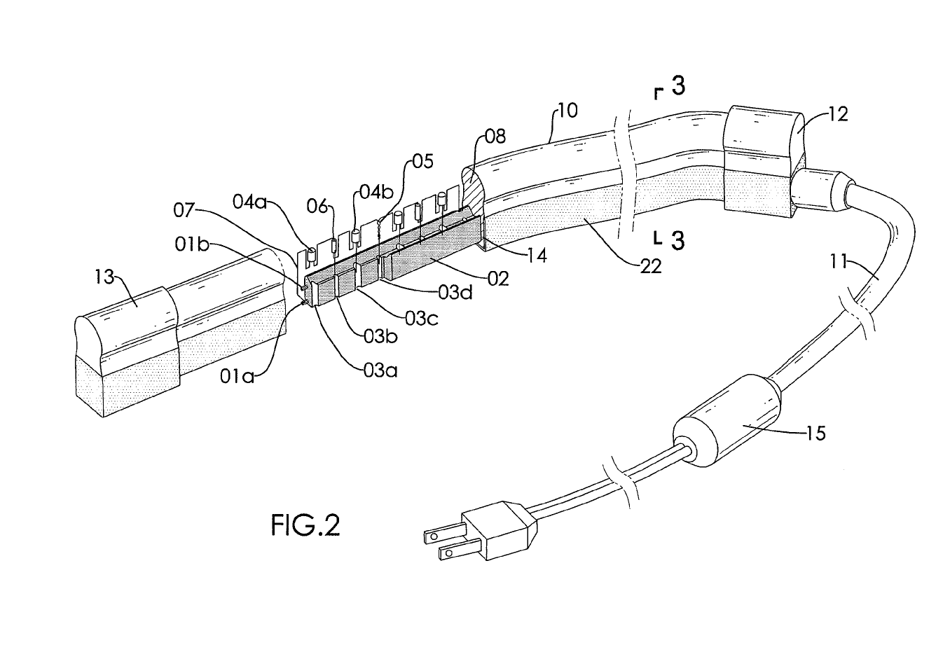

With reference to FIGS. 1, 2 and 3, it is noted that the rope light in accordance with the present invention includes a core (02) having multiple longitudinal slits (03a,03b,03c,03d) longitudinally defined in the core (02) to intermittently receive therein light emitting diodes (04a,04b) and joints (05) of wires (07) connecting two adjacent LEDs (04a,04b) together as well as resistors (06) and two conductive wires (01a,01b) embedded in the core (02) to be opposite to those of the longitudinal slits (03a,03b,03c,03d). An electrical wire (11) is electrically connected to both of the conductive wires (01a,01b) and has a connecting head (12) formed on the electrical wire (11), a plug (13) at a distal end of the electrical wire (11) and a rectifier (15) formed on a portion of the electrical wire (11) close to the proximal end of the electrical wire (11).

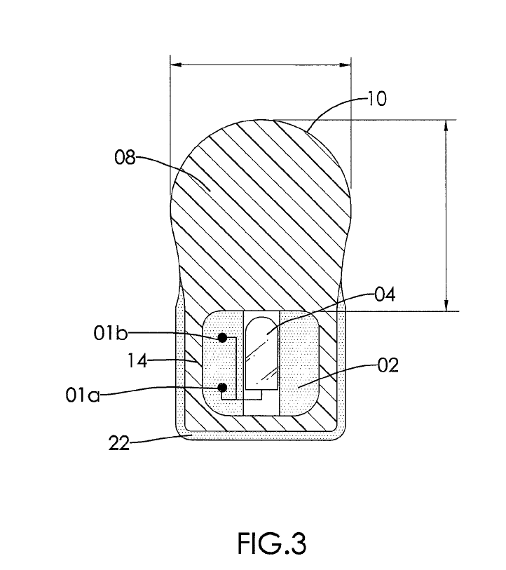

A refracting layer (14) is integrally formed on top of the core (02) and is made of a translucent material so that light from the LEDs (04a,04b) is able to penetrate through the translucent refracting layer (14). It is to be noted that the refracting layer (14) is provided with a dome (10), as shown in FIG. 3, having a height (H) preferably between 14-18 mm and a width preferably between 15-20 mm. Preferably, the refracting layer (14) has an elongated body (08) formed with the core (02) and the dome (10) is directly on top of the LEDs (04) in FIG. 3. An opaque layer (22) is painted at the bottom and on two opposed sides of the core (02) to prevent any light loss from the LEDs (04a,04b).

The refracting layer (14) may be formed by extrusion or other suitable methods known in the art. After the rope light is assembled, it is noted that light loss from the bottom of the rope light of the present invention is prevented due to the provision of the opaque layer (22) and bright intensity is increased due to the reflection from the provision of the refracting layer (14). Because the light from the LEDs (04) is reflected while penetrating through the refracting layer (14), the brightness of the rope light of the present invention is increased.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rope light comprising:
a core having multiple axial slits axially defined in the core to intermittently receive therein light emitting diodes (LEDs) and joints of wires connecting two adjacent LEDs together as well as resistors and two conductive wires embedded in the core to be opposite to those of the longitudinal slits;
an electrical wire electrically connected to both of the conductive wires and having a connecting head formed on the electrical wire, a plug at a distal end of the electrical wire and a rectifier formed on a portion of the electrical wire close to the proximal end of the electrical wire;
a refracting layer, made of a translucent material, integrally formed on top of the core to allow light from the LEDs to penetrate through the refracting layer, wherein the refracting layer is provided with a dome having a height between 14-18 mm and a width preferably between 15-20 mm, the refracting layer has an elongated body formed with the core and the dome is directly on top of the LEDs; and
an opaque layer provided at the bottom and on two opposed sides of the core to prevent any light loss from the LEDs.
